(19) United States
(12) Patent Application Publication
(10) Pub. No.: US 2025/0343295 A1
(43) Pub. Date: Nov. 6, 2025

(54) Battery Module and Vehicle Including Same

(71) Applicants: Hyundai Motor Company, Seoul (KR); Kia Corporation, Seoul (KR)

(72) Inventor: Gun Goo Lee, Suwon-Si (KR)

(21) Appl. No.: 18/945,855

(22) Filed: Nov. 13, 2024

(30) Foreign Application Priority Data
May 2, 2024 (KR) 10-2024-0058618

(51) Int. Cl. H01M 10/6557; B60L 50/64; H01M 10/613; H01M 10/625; H01M 10/647; H01M 10/6554; H01M 10/6569; H01M 50/211; H01M 50/249

(52) U.S. Cl. CPC H01M 10/6557; B60L 50/64; H01M 10/613; H01M 10/625; H01M 10/647; H01M 10/6554; H01M 10/6569; H01M 50/211; H01M 50/249; H01M 2220/20

(57) ABSTRACT

A battery module may include: a plurality of battery cells that are stacked; a vapor chamber disposed between the plurality of battery cells and provided with a refrigerant therein; and a cooling pad provided to cool the vapor chamber, wherein the vapor chamber may include a main chamber and a subchamber of a sealed structure.

### CROSS-REFERENCE TO RELATED APPLICATION

This application claims the priority and benefit of Korean Patent Application No. 10-2024-0058618, filed on May 2, 2024 with the Korean Intellectual Property Office, the disclosure of which is incorporated herein by reference.

### BACKGROUND

The present disclosure relates to a battery module and a vehicle including the same.

In recent years, the development and production of vehicles using a secondary battery as an energy source have been actively conducted to reduce greenhouse gas emissions. Specifically, a battery module may be mounted in a vehicle as an energy source for the vehicle, and the battery module may be provided with a plurality of battery cells, which may be secondary batteries.

When the battery module operates to supply energy to the vehicle, a change in voltage may occur in each battery cell, and a temperature of the battery cell may increase. For normal operation of the battery module, the temperature of the battery cells should be maintained at an appropriate and uniform temperature throughout.

The temperature of the battery cell may increase due to a battery module's lack of uniform operation throughout one or more battery cells. For example, the fastest and highest temperature increase may occur around an electrode of the battery cell.

Therefore, a battery module provided with a cooling means that may effectively cool an area around the electrode of the battery cell may be beneficial.

### SUMMARY

According to one or more examples of the present disclosure, a battery module may comprise a plurality of battery cells which may be stacked and a sealed vapor chamber which may be disposed between neighboring cells of the plurality of battery cells. Further, a refrigerant may be provided in the sealed vapor chamber. Additionally, the sealed vapor chamber may comprise a main chamber and a subchamber, and a cooling pad which may be configured to cool the sealed vapor chamber.

The main chamber and the subchamber may be partitioned by a partitioning member inside the sealed vapor chamber.

The sealed vapor chamber may comprise an exterior housing formed by a first housing and a second housing, and the partitioning member may be formed integrally with at least one of the first housing or the second housing.

The sealed vapor chamber may comprise an exterior housing formed by a first housing and a second housing, the partitioning member may be disposed between the first housing and the second housing as a separate member.

The refrigerant may be in a liquid state, and a level of the refrigerant in the subchamber may be higher than a level of the refrigerant in the main chamber.

The battery module may further comprise a wick which may be disposed in the main chamber and the subchamber. Further, the refrigerant may flow through the wick in a liquid state.

The battery module may further comprise a plurality of spacing members which may be disposed inside the sealed vapor chamber. The refrigerant may flow between the plurality of spacing members in a vapor state.

The subchamber may comprise a first subchamber and a second subchamber. The first subchamber may be disposed on a first side of the main chamber and the second subchamber may be disposed on a second side of the main chamber.

The battery module may further comprise a heat transfer member which may be disposed between the plurality of battery cells. The heat transfer member may be disposed between one of the plurality of battery cells and the cooling pad.

The cooling pad may be disposed to overlap the sealed vapor chamber in a direction perpendicular to a direction in which the plurality of battery cells may be stacked.

Each battery cell of the battery cells may comprise a body portion; and an electrode which may be disposed in an edge region of the body portion.

The main chamber and the subchamber may be configured separately from each other.

Each battery cell of the plurality of battery cells may comprise an electrode, and at least a portion of the electrode may be disposed to overlap the subchamber in a direction in which the plurality of battery cells may be stacked.

The sealed vapor chamber may further comprise a first housing and a second housing. The first housing and the second housing may form an exterior surface of the sealed vapor chamber. Additionally, one or more spacing members may be disposed between the first housing and the second housing. Further, a first wick may be disposed between the first housing and the spacing member, and a second wick may be disposed between the spacing member and the second housing.

The first wick and the second wick may comprise a porous material for transporting a liquid refrigerant through the sealed vapor chamber.

According to one or more examples of the present disclosure, a vehicle may comprise a motor and a battery module which may be configured to supply energy to the motor. The battery module may comprise a plurality of battery cells and a sealed vapor chamber which may be disposed between neighboring cells of the plurality of battery cells. A refrigerant may be provided in the sealed vapor chamber. The sealed vapor chamber may comprise a main chamber and a subchamber.

The sealed vapor chamber may further comprise a first housing and a second housing. The first housing and the second housing may form an exterior surface of the sealed vapor chamber. The sealed vapor chamber may further comprise one or more spacing members which may be disposed between the first housing and the second housing. Additionally, the sealed vapor chamber may further comprise a first wick which may be disposed between the first housing and the spacing member and a second wick which may be disposed between the spacing member and the second housing.

The first wick and the second wick may comprise a porous material for transporting the refrigerant through the sealed vapor chamber.

The sealed vapor chamber may further comprise a cooling pad which may be located opposite to an exterior surface of the sealed vapor chamber. A vapor refrigerant may travel through the sealed vapor chamber and may condenses to a liquid as the refrigerant moves towards the cooling pad.

According to one or more examples of the present disclosure, a sealed vapor chamber may comprise a main chamber, a subchamber which may surround the main chamber, a first housing, and a second housing which may be coupled to the first housing. The first housing and the second housing may form an exterior surface of the sealed vapor chamber and may accommodate the main chamber and the subchamber. Further, the sealed vapor chamber may comprise a spacing member which may be disposed between the first housing and the second housing, a first wick which may be disposed between the first housing and the spacing member, a second wick which may be disposed between the spacing member and the second housing, and a refrigerant which may flow through the main chamber and the subchamber via the first wick and the second wick. The first housing may be positioned adjacent to a battery cell of a plurality of battery cells. The plurality of battery cells may be stacked. The second housing may be positioned adjacent to a heat transfer member.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a perspective view illustrating a battery module according to an example of the present disclosure;

FIG. 2 is an exploded perspective view illustrating a battery module according to an example of the present disclosure;

FIG. 3 is a diagram illustrating a side view of a battery module according to the present disclosure;

FIGS. 4 and 5 are diagrams illustrating a structure of battery cells and vapor chambers disposed in a battery module;

FIG. 6 is a diagram conceptually illustrating an internal structure of a vapor chamber according to an example of the present disclosure;

FIG. 7 illustrates a B-B′ cross-section of a vapor chamber according to an example of the present disclosure;

FIG. 8 illustrates a C-C′ cross-section of a vapor chamber according to an example of the present disclosure;

FIG. 9 is a diagram illustrating a structure of battery cells and vapor chambers disposed in a battery module as an example; and

FIG. 10 is a diagram conceptually illustrating an example of an internal structure of a vapor chamber.

### DETAILED DESCRIPTION

Hereinafter, the present disclosure will be described in detail with reference to the accompanying drawings. In adding reference numerals to elements of each of the drawings, although the same elements are illustrated in other drawings, like reference numerals may refer to like elements. Since the present disclosure can make various changes and have various examples, specific examples are illustrated in the drawings and described in detail. However, this is not intended to limit the present disclosure to specific examples, and should be understood to include all modifications, equivalents, and substitutes included in the spirit and scope of the present disclosure. For instance, details from one example may be used in a second example.

Terms such as “first,” “second,” and the like, may be used to describe various components, but the components are not intended to be limited by the terms. These terms are used for the purpose of distinguishing one component from another component. The term ‘and/or’ includes a combination of a plurality of related recited items or any one of a plurality of related recited items.

Terms such as “unit,” “part,” “portion,” and the like, may be used to describe various components, but the components should not be limited by the terms.

Terms used in this application are used to describe examples, and are not intended to limit the present disclosure. Singular expressions include plural expressions unless the context thereof is clearly dictated otherwise. In this application, terms such as “comprise” or “having” are intended to designate that there is a feature, number, step, operation, component, parts, or a combination thereof described in the specification, but it should be understood that it does not preclude the possibility of the presence or addition of one or more other features, numbers, steps, operations, components, parts, or combinations thereof.

In the present specification, a vehicle refers to various vehicles moving objects to be transported such as people, animals, or goods from a starting point to a destination. The vehicle is not limited to a vehicle running on roads or tracks. In addition, the vehicle may not only include a vehicle powered by fossil fuels such as gasoline, but may also include vehicles using batteries or the like, and vehicles using fuels such as hydrogen.

In the description below, terms in relation to a direction in the description below such as “front,” “rear,” “lateral,” “front,” “back,” “up and down,” “above,” “upper,” “upper portion,” below,” “lower,” “lower portion, “left and right,” and the like are defined based on a vehicle or a vehicle body. In addition, terms such as “first,” “second,” and the like, may be used to describe various components, but the components should not be limited by the terms. These terms may be used for the purpose of distinguishing one component from another component.

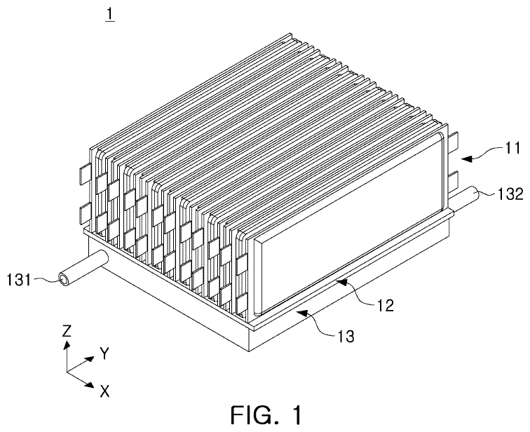

FIG. 1 is a perspective view illustrating a battery module according to an example of the present disclosure, and

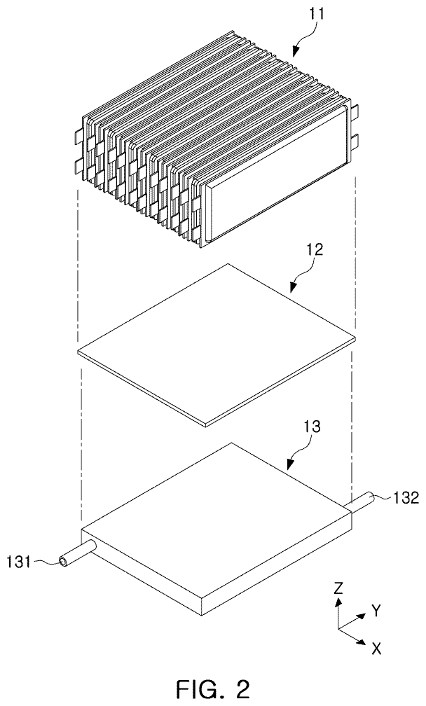

FIG. 2 is an exploded perspective view illustrating a battery module according to an example of the present disclosure.

The battery module 1 may include a plurality of battery cells 11 which may be stacked and disposed. Here, the direction in which the plurality of battery cells 11 are stacked may be referred to as a first direction (X-axis direction). The battery module 1 may be a secondary battery cell.

One or more heat transfer members may be disposed between the plurality of battery cells 11 to facilitate heat transfer. For example, a heat transfer member disposed between two neighboring battery cells of the plurality of battery cells 11 may be referred to as a first heat transfer member 300. Additionally or alternatively, the heat transfer member 300 may be disposed beneath one or more battery cells of the plurality of battery cells 11. The plurality of battery cells 11 and the first heat transfer member 300 may face each other in the first direction (X-axis direction). For example, the first heat transfer member 300 may be a heat sink formed of a material having high thermal conductivity. Here, the material having high thermal conductivity may be copper, for example.

A cooling pad 13 may be disposed below the battery module 1 to absorb heat generated by the plurality of battery cells 11. For example, the cooling pad 13 may be disposed below the plurality of battery cells 11. Additionally or alternatively, the cooling pad 13 may be disposed above the battery module 1.

That is, a location of the cooling pad 13 may vary depending on the structure of the battery module 1, and may be disposed at a location facing the plurality of battery cells 11. For example, based on FIGS. 1 and 2, a cooling pad 13 may be disposed above or below the plurality of battery cells 11 rather than on a side surface of the plurality of battery cells 11. In other words, the cooling pad 13 may be disposed to face the plurality of battery cells in a second direction (Y-axis direction) perpendicular to the first direction (X-axis direction).

Cooling fluid may flow inside the cooling pad 13. That is, a channel through which cooling fluid flows may be formed inside the cooling pad 13. Accordingly, a cooling fluid inlet 131 for introducing cooling fluid may be disposed in a portion of the cooling pad 13, and a cooling fluid outlet 132 for discharging the cooling fluid may be disposed in another portion of the cooling pad 13. The cooling fluid may be, for example, water. However, considering the usage environment of the battery module 1, the cooling fluid may be a liquid other than water or an additive mixed with water, or a liquid other than water may be used alone. For example, the cooling fluid may be a glycol-based mixture. Further, the cooling fluid may include one or more dielectric liquids, for example mineral oil, silicon oil, biologic oils, fluorocarbons, or other cooling fluid. However, in consideration of the possibility of fire in the plurality of battery cells 11 or the battery module 1, it is preferable that the cooling fluid be a non-flammable material.

A second heat transfer member may be disposed between the plurality of battery cells 11 and the cooling pad 13. In this case, the second heat transfer member disposed between the plurality of battery cells 11 and the cooling pad 13 may be referred to as a second heat transfer member 12. The second heat transfer member 12 may be formed of a material having high thermal conductivity. For example, the material of the second heat transfer member 12 may be one or more of copper, copper alloys, aluminum, aluminum alloys, or other heat transferring materials.

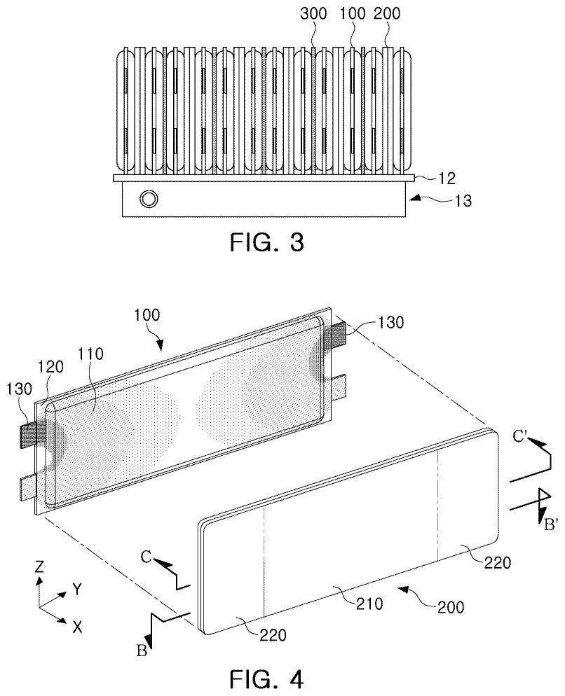

FIG. 3 is a diagram illustrating a side surface of a battery module according to the present disclosure.

One or more battery cells 100 may be stacked in the battery module 1. A means for cooling may be disposed between each of the one or more battery cells 100. For example, the means for cooling may include a vapor chamber 200 and the first heat transfer member 300 described above.

Referring to FIG. 3, the vapor chamber 200 may be disposed between neighboring battery cells of the one or more battery cells 100, and the first heat transfer member 300 may be also disposed between neighboring battery cells of the one or more battery cells 100. That is, the vapor chamber 200 may be disposed to face the one or more battery cells 100 in a first direction (X-axis direction). In other words, the vapor chamber 200 may be disposed to be stacked with the one or more battery cells 100 in the first direction (X-axis direction).

Further, the vapor chamber 200 is disposed to directly face the one or more battery cells 100, and the first heat transfer member 300 is also disposed to directly face the one or more battery cells 100. However, the disposition of the vapor chamber 200 and the first heat transfer member 300 is not limited thereto. Specifically, both the vapor chamber 200 and the first heat transfer member 300 may be disposed between neighboring battery cells of the one or more battery cells 100. Further, a plurality of vapor chambers 200 may be disposed between multiple neighboring battery cells of the one or more battery cells 100. A plurality of first heat transfer members 300 may also be disposed between multiple neighboring battery cells of the one or more battery cells 100. In addition, the plurality of vapor chambers 200 may be sequentially disposed with the first heat transfer members 300, but alternatively, the plurality of vapor chambers 200 may be sequentially disposed with each other. In addition, the plurality of first heat transfer members 300 may be sequentially disposed with the vapor chamber 200, but alternatively, the plurality of first heat transfer members 300 may be sequentially disposed with each other.

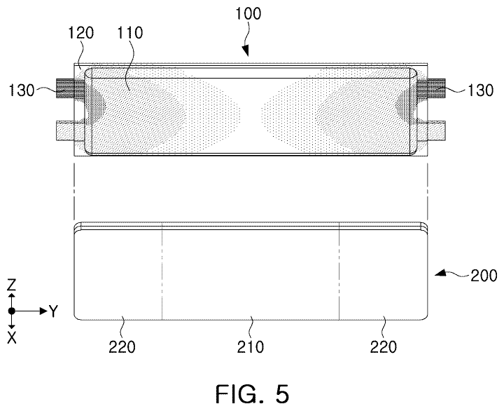

FIGS. 4 and 5 are diagrams illustrating a dispositional structure of battery cells and vapor chambers disposed in a battery module. In FIGS. 4 and 5, a battery cell of the one or more battery cells 100 and a vapor chamber 200 may be directly facing each other, but a first heat transfer member 300, as described above, may be disposed in singular or plural, and other members may be disposed.

The one or more battery cells 100 may be a pouch-type, prismatic-type, or cylindrical type secondary battery depending on the structure of the case. In the example of the present disclosure, the one or more battery cells 100 are illustrated and described as a pouch type, but the present disclosure is not limited thereto. That is, as another example, the one or more battery cells 100 may be a prismatic secondary battery.

The case may form an exterior of the one or more battery cells 100. The case may include a body portion 110 accommodating an electrode assembly and an electrolyte in an accommodation space, and a sealing portion 120 formed on at least one edge of the body portion to seal the accommodation space.

The body portion 110 may include a space for accommodating the electrode assembly and may be an unsealed portion of the case. In other words, the body portion 110 may refer to a part of the case other than the sealing portion 120.

An electrode 130 may be disposed in an edge region of the one or more battery cells 100. That is, the electrode 130 may be disposed to protrude to the outside of the one or more battery cells 100, passing through the sealing portion 120 of the one or more battery cells 100. In other words, at least a portion of the electrode 130 may be disposed inside the one or more battery cells 100, and another portion of the electrode 130 may be disposed outside the one or more battery cells 100.

A plurality of electrodes 130 may be disposed with the battery stack. For example, the plurality of electrodes 130 may be disposed along the edge of the one or more battery cells 100. As another example, the electrodes may be disposed on one side of the one or more battery cells 100 and the other side thereof opposite the one side. The present disclosure is not limited thereto.

The vapor chamber 200 may include a main chamber 210 and a subchamber 220 disposed to extend from the main chamber 210.

The main chamber 210 may be disposed to be connected to the subchamber 220. The subchamber 220 may be disposed in an edge region of the main chamber 210. That is, the subchamber 220 may be disposed around the main chamber 210.

The main chamber 210 may be disposed to face the body portion 110 of the one or more battery cells 100. That is, the main chamber 210 may be disposed to overlap the one or more battery cells 100 in a direction perpendicular to a longitudinal direction of the one or more battery cells 100.

The subchamber 220 may be disposed around the main chamber 210. The subchamber 220 may be disposed around the main chamber 210 and disposed to overlap an edge region of the one or more battery cells 100 in the first direction. The subchamber 220 may be disposed to overlap at least a portion of the electrode 130 in the first direction (X-axis direction).

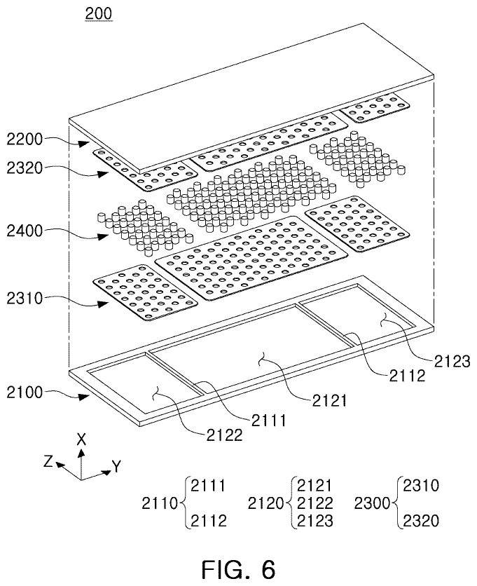

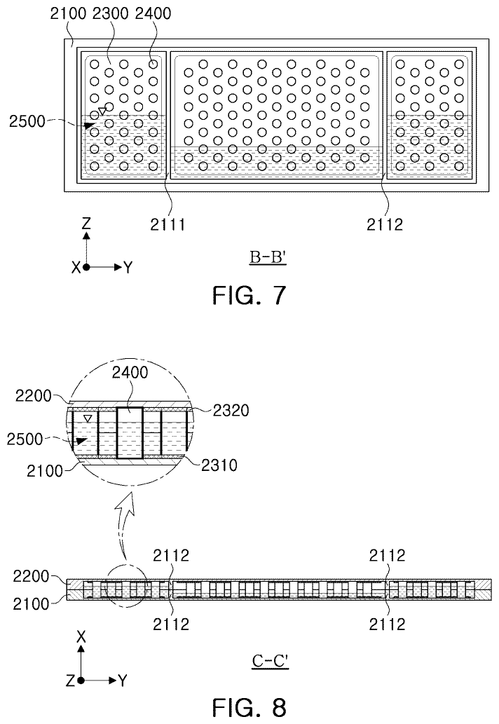

FIG. 6 is a diagram conceptually illustrating an internal structure of a vapor chamber according to an example of the present disclosure. FIG. 7 is a diagram illustrating a B-B′ cross-section of the vapor chamber according to an example of the present disclosure. FIG. 8 is a diagram illustrating a C-C′ cross-section of a vapor chamber according to an example of the present disclosure.

A structure of the vapor chamber 200 according to an example of the present disclosure will be described with reference to FIGS. 6 to 8.

The vapor chamber 200 may include a first housing 2100, a second housing 2200, a first wick 2310, a second wick 2320, a spacing member 2400, and a refrigerant 2500.

Referring to FIG. 6, the first housing 2100 and the second housing 2200 may be disposed vertically to form an exterior of the vapor chamber 200, and a separation space is formed between the first housing 2100 and the second housing 2200. The first housing 2100 and the second housing 2200 may be coupled with the edges thereof being in close contact with each other.

A partitioning member 2110 may be disposed in the separation space. That is, the partitioning member 2110 may be disposed between the first housing 2100 and the second housing 2200. The partitioning member 2110 may be a separate member from the first housing 2100 and the second housing 2200. However, as another example, the partitioning member 2110 may be formed by a portion of the first housing 2100 or the second housing 2200 protruding toward the separation space. That is, the partitioning member 2110 may be formed integrally with the first housing 2100 or the second housing 2200.

The main chamber 210 and the subchamber 220 of the vapor chamber 200 may be distinguished from each other by the partitioning member 2110. Additionally, two partitioning members 2110 may be provided. One of the two partitioning members 2110 may be referred to as a first partitioning member 2111, and the other may be referred to as a second partitioning member 2112.

When the first partitioning member 2111 and the second partitioning member 2112 are disposed between the first housing 2100 and the second housing 2200, the separation space formed between the first housing 2100 and the second housing 2200 may be divided into three spaces. The separation space disposed between the first partitioning member 2111 and the second partitioning member 2112 may be referred to as a first separation space 2121, and the first separation space 2121 may correspond to a region corresponding to the main chamber 210 described above. Further, one of the separation spaces formed on the left and right sides of the first separation space 2121 may be referred to as a second separation space 2122, and the other thereof may be referred to as a third separation space 2123. For example, the second separation space 2122 and the third separation space 2123 may correspond to a region corresponding to the subchamber 220.

The vapor chamber 200 may be disposed in the separation space 2120. The configurations disposed in the first to third separation spaces 2121, 2122, and 2123 may be the same. In the following description, it is assumed that members disposed inside the separation space 2120 may be respectively disposed in all of the first to third separation spaces 2121, 2122, and 2123.

A wick 2300, a spacing member 2400, and a refrigerant 2500 may be disposed in the separation space 2120. That is, the vapor chamber 200 may be sealed with the wick 2300, the spacing member 2400, and the refrigerant 2500 disposed in the space 2120 between the first housing 2100 and the second housing 2200.

The wick 2300 may include a first wick 2310 and a second wick 2320. The wick 2300 may be disposed on the first housing 2100 and the second housing 2200. A wick disposed on one of the first housing 2100 or the second housing 2200 may be referred to as a first wick 2310, and a wick disposed on the other thereof may be referred to as a second wick 2320.

The wick 2300 may refer to a porous structure for moving the refrigerant in a liquid state 2500 through a capillary shape. As an example, wick 2300 may be formed of copper wire mesh, copper braided wire, or copper knit wire.

The spacing members 2400 may be disposed in plural numbers. The spacing member 2400 may be disposed between the first housing 2100 and the second housing 2200 to support a separation space between the first housing 2100 and the second housing 2200. In addition, a plurality of spacing members 2400 may be disposed to form a vapor flow path. That is, a refrigerant in a vapor state may move through a space formed between the plurality of spacing members 2400. Specifically, the refrigerant 2500 may be heated by a heat source around the vapor chamber 200 and change into vapor, and the vapor may move toward a low-temperature heat source through the vapor flow path formed between the plurality of spacing members 2400. The vapor moving toward the low-temperature heat source may condensed back into a liquid state, and may move toward the high-temperature heat source through the wick 2300. In an example of the present disclosure, the high-temperature heat source may be the battery cell 100, and the low-temperature heat source may be the cooling pad 13. The spacing member 2400 may be formed of a material having high thermal conductivity for heat transfer. In addition, the spacing member 2400 may be formed of the same material as the first housing 2100 or the second housing 2200.

FIGS. 7 and 8 are diagrams conceptually illustrating a cross-section of a vapor chamber according to an example of the present disclosure.

A refrigerant 2500 may be disposed inside each of a main chamber 210 and a subchamber 220. In this case, the refrigerant 2500 disposed in each of the main chamber 210 and the subchamber 220 may be the same refrigerant 2500.

Based on FIGS. 7 and 8, a level of the refrigerant 2500 disposed in the subchamber 220 may be higher than a level of the refrigerant 2500 disposed in the main chamber 210. In this case, the level of the refrigerant 2500 may mean a height of the refrigerant 2500 in a liquid state when measured based on a state in which the vapor chamber 200 may be lying on the ground. Specifically, based on FIG. 6, a surface formed by the first housing 2100 may be referred to as a lower surface of the vapor chamber 200, and a surface formed by the second housing 2200 may be referred to as an upper surface of the vapor chamber 200. Therefore, a height of the refrigerant 2500 in a liquid state when measured based on a direction of gravity in a state in which the upper or lower surface of the vapor chamber 200 is disposed to be parallel to the ground may be defined as a level of the refrigerant 2500.

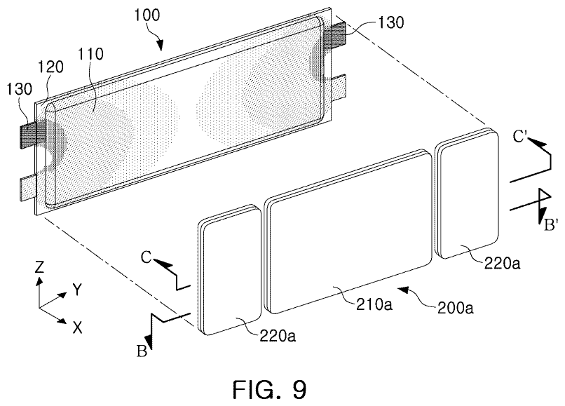

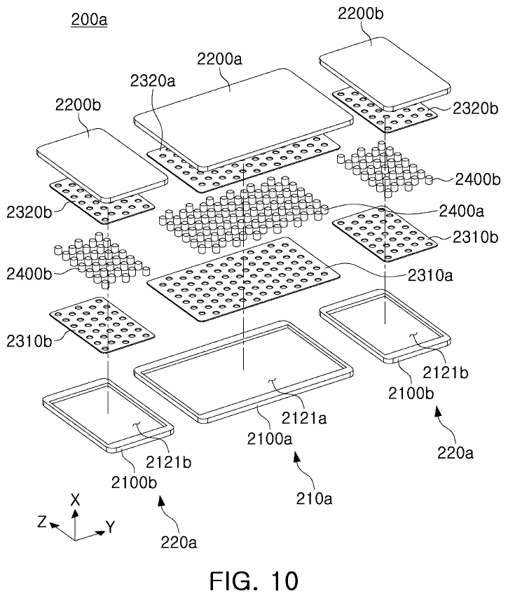

FIG. 9 is a diagram illustrating a dispositional structure of a battery cell and a vapor chamber disposed in a battery module as another example, and FIG. 10 is a diagram conceptually illustrating an internal structure of a vapor chamber as another example.

Hereinafter, another example of the battery module 1 according to the present disclosure will be described with reference to FIGS. 9 and 10. For reference, contents that overlap with contents described in relation to the previous example will be omitted and described.

A vapor chamber 200a may include a main chamber 210a and a subchamber 220a. The main chamber 210a and the subchamber 220a may be separate and independent from each other. That is, the main chamber 210a and the subchamber 220a may be respectively provided, the subchamber 220a may be disposed on one side or the other side of the main chamber 210a, and a plurality of subchambers 220a may be provided and disposed on one side and the other side of the main chamber 210a.

The main chamber 210a may include a 1-1 housing 2100a, a 2-1 housing 2200a, a 1-1 wick 2310a, a 2-1 wick 2320a, a first spacing member 2400a, and a refrigerant.

Referring to FIG. 10, the 1-1 housing 2100a and the 2-1 housing 2200a may be disposed vertically to form an exterior of the main chamber 210a, and a first separation space 2121a is formed between the 1-1 housing 2100a and the 2-1 housing 2200a. The 1-1 housing 2100a and the 2-1 housing 2200a may be coupled with the edges thereof in close contact with each other.

The subchamber 220a may include a 1-2 housing 2100; , a 2-2 housing 2200b, a 1-2 wick 2310b, a 2-2 wick 2320b, a second spacing member 2400b, and a refrigerant.

Referring to FIG. 10, the 1-2 housing 2100b and the 2-2 housing 2200b may be disposed vertically to form an exterior of the subchamber 220a, and a 1-2 separation space 2121b may be formed between the 1-2 housing 2100b and the 2-2 housing 2200b. The 1-2 housing 2100b and the 2-2 housing 2200b may be coupled with the edges thereof being in close contact with each other.

Hereinafter, the effect of a battery module according to an example of the present disclosure will be described with reference to FIGS. 4 to 10.

When the battery module 1 operates, current is formed in each battery cell of the one or more battery cells 100, and accordingly, a temperature of the battery cells in the one or more battery cells 100 generally increases. Shading displayed on the battery cell of the one or more battery cells 100 in FIGS. 4 and 5 conceptually illustrates the temperature distribution of the battery cell of the one or more battery cells 100, with darker shading indicating a relatively higher temperature. The temperature of the battery cell of the one or more battery cells 100 tends to increase first and highest around an electrode 130.

In particular, the battery module 1 according to the present disclosure may be mounted on a vehicle using electricity as an energy source and a motor as a power source. Since the vehicle requires high voltage, the temperature of each battery cell of the one or more battery cells 100 may increase rapidly.

The vapor chamber 200 according to an example of the present disclosure may be disposed to face and overlap the one or more battery cells 100 in a first direction (X-axis direction). In this case, the main chamber 210 may be disposed to overlap the body portion 110 of a battery cell of the one or more battery cells 100 in the first direction (X-axis direction), and the subchamber 220 is disposed to overlap at least a portion of the electrode 130 of the battery cell of the one or more battery cells 100 in the first direction.

Since the subchamber 220 may include a separation space, distinguished from the main chamber 210 and a refrigerant 2500, a certain level of refrigerant distribution may be maintained around the electrode of the one or more battery cells 100.

Therefore, even if a rapid temperature increase) occurs in the electrode 130, the area around the electrode 130 may be effectively cooled through the refrigerant 2500 in the subchamber 220.

As set forth above, according to an example of the present disclosure, a battery module may maintain a temperature of the battery module at an appropriate temperature by appropriately cooling an area around an electrode of a battery cell.

An aspect of the present disclosure is to provide a battery module capable of stable operation by rapidly cooling an area around an electrode of a battery cell and a vehicle including the same.

According to an aspect of the present disclosure, a battery module may include a plurality of battery cells that are stacked; a sealed vapor chamber may be disposed between neighboring cells of the plurality of battery cells. A refrigerant may be provided in the sealed vapor chamber. The sealed vapor chamber may comprise a main chamber and a subchamber. A cooling pad may be configured to cool the sealed vapor chamber. Further, the main chamber and the subchamber may be partitioned by a partitioning member inside the sealed vapor chamber.

The sealed vapor chamber may include a first housing and a second housing forming an exterior, and the partitioning member may be formed integrally with the first housing or the second housing.

The sealed vapor chamber may include a first housing and a second housing forming an exterior, and the partitioning member may be disposed between the first housing and the second housing as a separate member.

Based on a case in which the refrigerant may be in a liquid state, a level of the refrigerant in the subchamber may be higher than a level of the refrigerant in the main chamber.

A wick through which the refrigerant flows in a liquid state may be disposed in the main chamber and the subchamber.

A plurality of spacing members may be disposed inside the vapor chamber, and the refrigerant may flow between the plurality of spacing members in a vapor state.

The subchamber may be respectively disposed on one side and the other side of the main chamber.

A heat transfer member disposed between the plurality of battery cells may be included.

A heat transfer member disposed between the plurality of battery cells and the cooling pad may be included.

The cooling pad may be disposed to overlap the vapor chamber in a direction perpendicular to a direction in which the plurality of battery cells are stacked.

Each of the battery cells may include a body portion and an electrode, and the electrode may be disposed in an edge region of the body portion.

The main chamber and the subchamber may be provided separately from each other.

Each of the plurality of battery cells may include an electrode, and at least a portion of the electrode may be disposed to overlap the subchamber in a stacking direction of the plurality of battery cells.

According to an aspect of the present disclosure, a vehicle may include a motor; and a battery module supplying energy to the motor, wherein the battery module may include a plurality of battery cells and a vapor chamber disposed between the plurality of battery cells, and the vapor chamber may include a main chamber and a subchamber of a sealed structure.

While exemplary examples have been illustrated and described above, it will be apparent to those skilled in the art that modifications and variations could be made without departing from the scope of the present invention as defined by the appended claims.

What is claimed is:

1. A battery module, comprising:
a plurality of battery cells that are stacked;
a sealed vapor chamber disposed between neighboring cells of the plurality of battery cells, wherein a refrigerant is provided in the sealed vapor chamber, and wherein the sealed vapor chamber comprises a main chamber and a subchamber; and
a cooling pad configured to cool the sealed vapor chamber.

2. The battery module of claim 1, wherein the main chamber and the subchamber are partitioned by a partitioning member inside the sealed vapor chamber.

3. The battery module of claim 2, wherein the sealed vapor chamber comprises an exterior housing formed by a first housing and a second housing, and
the partitioning member is formed integrally with at least one of the first housing or the second housing.

4. The battery module of claim 2, wherein the sealed vapor chamber comprises an exterior housing formed by a first housing and a second housing, and
the partitioning member is disposed between the first housing and the second housing as a separate member.

5. The battery module of claim 1, wherein the refrigerant is in a liquid state, and a level of the refrigerant in the subchamber is higher than a level of the refrigerant in the main chamber.

6. The battery module of claim 1, further comprising:
a wick disposed in the main chamber and the subchamber, wherein the refrigerant flows through the wick in a liquid state.

7. The battery module of claim 1, further comprising:
a plurality of spacing members disposed inside the sealed vapor chamber, wherein
the refrigerant flows between the plurality of spacing members in a vapor state.

8. The battery module of claim 1, wherein the subchamber comprises a first subchamber and a second subchamber, wherein the first subchamber is disposed on a first side of the main chamber and the second subchamber is disposed on a second side of the main chamber.

9. The battery module of claim 1, further comprising:
a heat transfer member disposed between the plurality of battery cells.

10. The battery module of claim 1, further comprising:
a heat transfer member disposed between one of the plurality of battery cells and the cooling pad.

11. The battery module of claim 1, wherein the cooling pad is disposed to overlap the sealed vapor chamber in a direction perpendicular to a direction in which the plurality of battery cells are stacked.

12. The battery module of claim 1, wherein each battery cell of the battery cells further comprises:
a body portion; and
an electrode disposed in an edge region of the body portion.

13. The battery module of claim 1, wherein the main chamber and the subchamber are configured separately from each other.

14. The battery module of claim 1, wherein each battery cell of the plurality of battery cells comprises an electrode, and
at least a portion of the electrode is disposed to overlap the subchamber in a direction in which the plurality of battery cells are stacked.

15. The battery module of claim 1, wherein the sealed vapor chamber further comprises:
a first housing;
a second housing, wherein the first housing and the second housing form an exterior surface of the sealed vapor chamber;
one or more spacing members disposed between the first housing and the second housing;
a first wick disposed between the first housing and the spacing member; and
a second wick disposed between the spacing member and the second housing.

16. A vehicle, comprising:
a motor; and
a battery module configured to supply energy to the motor,
wherein the battery module comprises:
a plurality of battery cells; and
a sealed vapor chamber disposed between neighboring cells of the plurality of battery cells, wherein a refrigerant is provided in the sealed vapor chamber, and wherein the sealed vapor chamber comprises a main chamber and a subchamber.

17. The vehicle of claim 16, wherein the sealed vapor chamber further comprises:
a first housing;
a second housing, wherein the first housing and the second housing form an exterior surface of the sealed vapor chamber;
one or more spacing members disposed between the first housing and the second housing;
a first wick disposed between the first housing and the spacing member; and
a second wick disposed between the spacing member and the second housing.

18. The vehicle of claim 17, wherein:
the first wick and the second wick comprise a porous material for transporting the refrigerant through the sealed vapor chamber.

19. The vehicle of claim 16, wherein the sealed vapor chamber further comprises:
a cooling pad located opposite to an exterior surface of the sealed vapor chamber, wherein a vapor refrigerant travels through the sealed vapor chamber and condenses to a liquid as the refrigerant moves towards the cooling pad.

20. A sealed vapor chamber comprising:
a main chamber;
a subchamber surrounding the main chamber;
a first housing;
a second housing coupled to the first housing, wherein the first housing and the second housing form an exterior surface of the sealed vapor chamber and accommodates the main chamber and the subchamber;
a spacing member disposed between the first housing and the second housing;
a first wick disposed between the first housing and the spacing member;
a second wick disposed between the spacing member and the second housing; and
a refrigerant that flows through the main chamber and the subchamber via the first wick and the second wick, wherein the first housing is positioned adjacent to a battery cell of a plurality of battery cells, wherein the plurality of battery cells are stacked, and wherein the second housing is positioned adjacent to a heat transfer member.
